(19) United States
(12) Patent Application Publication
(10) Pub. No.: US 2018/0081252 A1
(43) Pub. Date: Mar. 22, 2018

(54) LIQUID CRYSTAL LENS AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Ming YANG, Beijing (CN); Xiaochuan CHEN, Beijing (CN); Wenqing ZHAO, Beijing (CN); Qian WANG, Beijing (CN); Xiaochen NIU, Beijing (CN); Jian GAO, Beijing (CN); Lei WANG, Beijing (CN); Pengcheng LU, Beijing (CN); Rui XU, Beijing (CN)

(21) Appl. No.: 15/538,785

(22) PCT Filed: May 26, 2016
(86) PCT No.: PCT/CN2016/083464

§ 371 Date: Jun. 22, 2017

(30) Foreign Application Priority Data
Mar. 18, 2016 (CN) 201610159125.8

(51) Int. Cl. G02F 1/29; G02B 27/22

(52) U.S. Cl. CPC G02F 1/29; G02F 1/133528; G02F 2201/12; G02B 27/2214

(57) ABSTRACT

This disclosure relates to a liquid crystal lens and a display device. The liquid crystal lens includes a first substrate, a second substrate, a liquid crystal layer, a first transparent electrode, a second transparent electrode, and a control unit. The first transparent electrode is a planar electrode. The second transparent electrode is divided into a plurality of electrode groups, each electrode group includes a plurality of sub-electrodes.

The present application is the U.S. national phase entry of PCT/CN2016/083464, with an international filling date of May 26, 2016, which claims the benefit of Chinese Patent Application No. 201610159125.8, filed on Mar. 18, 2016, the entire disclosures of which are incorporated herein by reference.

### FIELD

This disclosure relates to the field of display techniques, and in particular to a liquid crystal lens and a display device.

### BACKGROUND ART

In recent years, a curved display has become a high-end product in the field of display due to advantages such as an arc-shaped design, a wider viewing angle, a feeling of being surrounded and the accordance with human visual anatomy. However, curved display products manufactured in a physical approach have some inherent disadvantages. For example, it is inconvenient to hang them on a wall, and they may also be easily broken when being curved. At present, there are only display products that realize naked-eye 3D display by using a liquid crystal lens, but not devices that realize a combination of a curved surface and 3D by using a flat display.

### SUMMARY

To this end, embodiments of this disclosure provide a liquid crystal lens and a display device, so as to combine 3D display and curved display by using a liquid crystal lens for flat display.

Therefore, one exemplary embodiment of this disclosure provides a liquid crystal lens including a first substrate and a second substrate arranged oppositely; a liquid crystal layer between the first substrate and the second substrate; a first transparent electrode and a second transparent electrode between the first substrate and the second substrate, wherein the first transparent electrode and the second transparent electrode are located on two opposing sides of the liquid crystal layer; and a control unit for applying voltages to the first transparent electrode and the second transparent electrode. The first transparent electrode is a planar electrode. The second transparent electrode is divided into a plurality of electrode groups, each of the electrode groups including a plurality of sub-electrodes. In a 3D display mode, the control unit is configured to apply a first voltage to the sub-electrodes in each of the electrode groups, and control liquid crystal molecules in a region of the liquid crystal layer corresponding to each of the electrode groups to deflect so as to form lenticular lens structures corresponding to the electrode groups. While in a curved display mode, the control unit is configured to apply a second voltage to the sub-electrodes in each of the electrode groups, control liquid crystal molecules in a region of the liquid crystal layer corresponding to each of the electrode groups to deflect so as to form micro-prism structures, and control a difference between equivalent optical paths of light in each of the micro-prism structures to compensate for a difference between optical paths from a position of a viewer to each of the micro-prism structures.

In certain exemplary embodiments of this disclosure, the plurality of sub-electrodes in each of the electrode groups are a plurality of strip sub-electrodes arranged in parallel.

In certain exemplary embodiments, the liquid crystal lens further includes an eye tracking unit, which is configured to determine a position of the viewer in front of the liquid crystal lens.

In certain exemplary embodiments of the liquid crystal lens provided by this disclosure, the closer the micro-prism structures are to the viewer, the greater equivalent optical paths the micro-prism structures have.

In certain exemplary embodiments of the liquid crystal lens provided by this disclosure, a difference between the equivalent optical paths in any two of the micro-prism structures is: S(Binner)-S(Ainner)=S/cos β−S. In the above expression, S is a distance from the viewer to a micro-prism structure B, S/cos β is a distance from the viewer to a micro-prism structure A, β is an opening angle between the micro-prism structure A and the micro-prism structure B when viewed by the viewer, S(Ainner) is an equivalent optical path in the micro-prism structure A, and S(Binner) is an equivalent optical path in the micro-prism structure B.

In certain exemplary embodiments of the liquid crystal lens provided by this disclosure, the greater equivalent optical paths the micro-prism structures have, the smaller a difference is between voltages applied to the first and second transparent electrodes on two opposing sides of the liquid crystal layer corresponding to the micro-prism structures.

In certain exemplary embodiments of the liquid crystal lens provided by this disclosure, the micro-prism structure includes at least one of a triangular prism structure and a quadrangular prism structure.

In certain exemplary embodiments of the liquid crystal lens provided by this disclosure, the sub-electrode includes at least one linear electrode or a plurality of dot electrodes.

In certain exemplary embodiments of the liquid crystal lens provided by this disclosure further includes a polarizer, which is located on a side of the first substrate facing away from the liquid crystal layer.

An exemplary embodiment of this disclosure further provides a display device, including the liquid crystal lens provided in the above embodiment of this disclosure. The display device further includes a display panel arranged below the liquid crystal lens and configured to display polarized light.

In certain exemplary embodiments of the display device provided by this disclosure, the display panel is a liquid crystal display panel, or an electroluminescent display panel with a polarizer provided on a display surface.

In certain exemplary embodiments, a display device including a liquid crystal lens. The liquid crystal lens specifically includes a first substrate and a second substrate arranged oppositely; a liquid crystal layer between the first substrate and the second substrate; a first transparent electrode and a second transparent electrode between the first substrate and the second substrate, wherein the first transparent electrode and the second transparent electrode are located on two opposing sides of the liquid crystal layer; and a control unit for applying a voltage to the first transparent electrode and the second transparent electrode. The first transparent electrode is a planar electrode. The second transparent electrode is divided into a plurality of electrode groups, each electrode group including a plurality of sub-electrodes. In a 3D display mode, the control unit is configured to apply a first voltage to the sub-electrodes in each electrode group, and control liquid crystal molecules in a region of the liquid crystal layer corresponding to each electrode group to deflect so as to form lenticular lens structures corresponding to each electrode group, thereby realizing a naked-eye 3D display function. In a curved display mode, the control unit is configured to apply a second voltage to the sub-electrodes in each electrode group, control liquid crystal molecules in a region of the liquid crystal layer corresponding to each of the electrode groups to deflect so as to form micro-prism structures, and control a difference between equivalent optical paths of light in each micro-prism structure to compensate for a difference between optical paths from the position of the viewer to each micro-prism structure, thereby realizing curved display. The above liquid crystal lens realizes a combination of a curved surface and 3D in case of flat display. This helps to avoid disadvantages of curved display when realized in a physical approach and facilitate an ultrathin product design combining 3D display and curved display.

### BRIEF DESCRIPTION OF DRAWINGS

FIG. 1 is a schematic structure view of a liquid crystal lens provided by an embodiment of this disclosure;

FIGS. 2a-2d are respectively schematic structure views of a second transparent electrode in a liquid crystal lens provided by an embodiment of this disclosure;

FIG. 3 is a schematic structure view of a liquid crystal lens provided by an embodiment of this disclosure in a 3D display mode;

FIG. 4 is a schematic structure view of a liquid crystal lens provided by an embodiment of this disclosure in a curved display mode; and

FIG. 5 is a schematic structure view of a display device provided by an embodiment of this disclosure.

### DETAILED DESCRIPTION OF EMBODIMENTS

Specific implementations of the liquid crystal lens and the display device provided in the embodiments of this disclosure will be illustrated in detail with reference to the drawings.

The shape and size of each component in the drawings are only provided to illustrate the contents of this disclosure, instead of reflecting the true proportions of the liquid crystal lens.

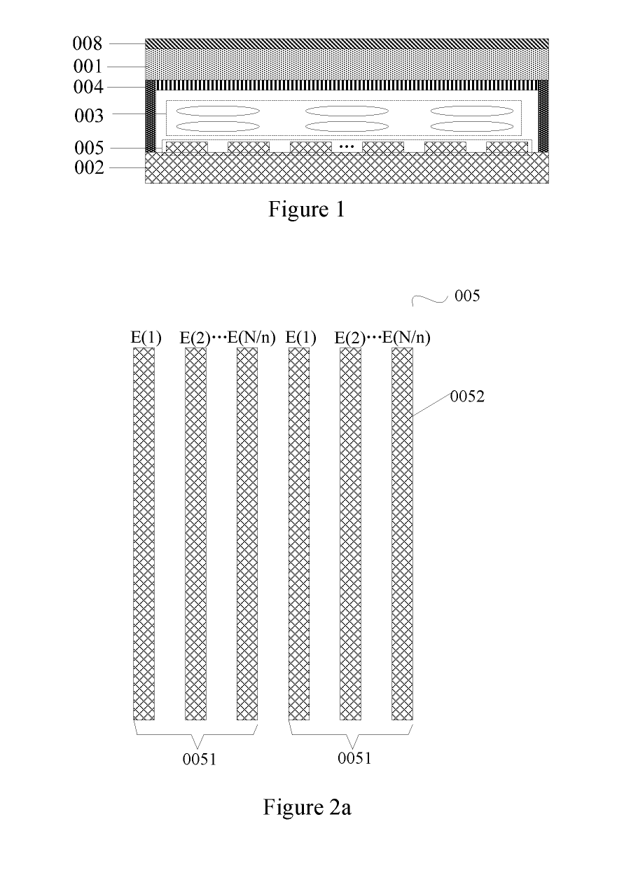

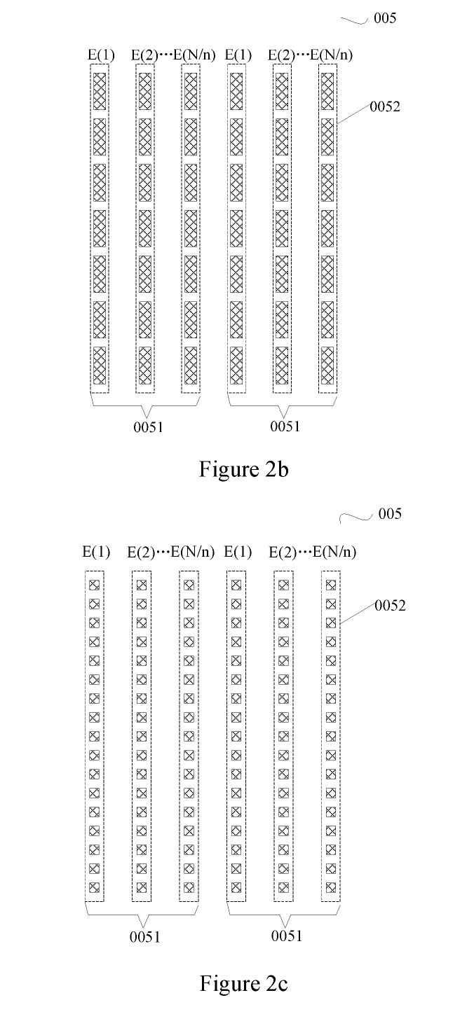

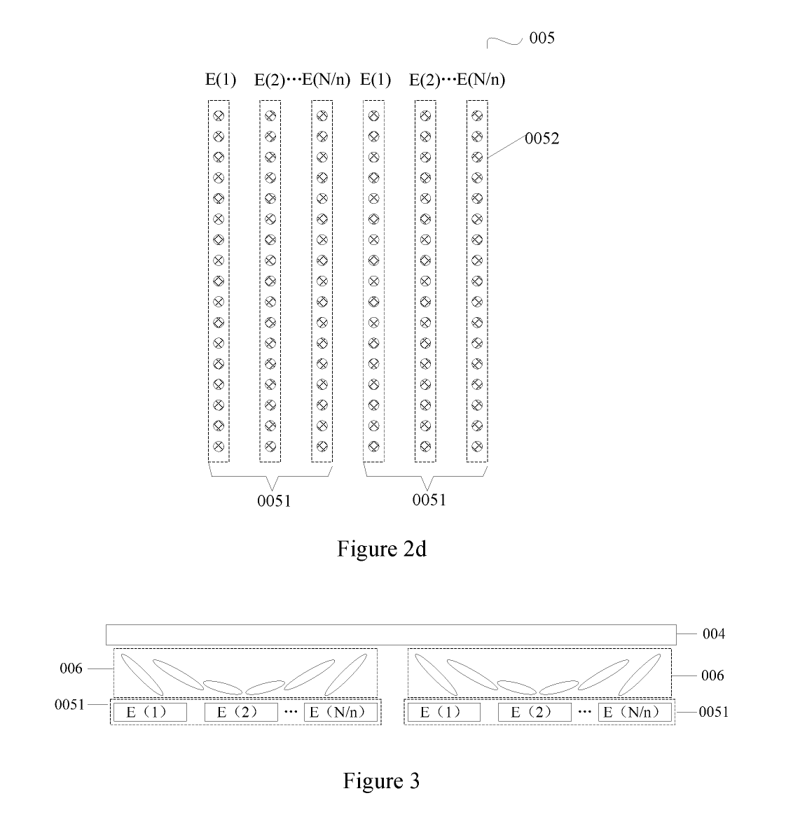

As shown in FIG. 1, an embodiment of this disclosure provides a liquid crystal lens comprising: a first substrate 001 and a second substrate 002 arranged oppositely; a liquid crystal layer 003 between the first substrate 001 and the second substrate 002; a first transparent electrode 004 and a second transparent electrode 005 between the first substrate 001 and the second substrate 002, wherein the first transparent electrode 004 and the second transparent electrode 005 are located on two opposing sides of the liquid crystal layer 003 respectively; and a control unit for applying a voltage to the first transparent electrode 004 and the second transparent electrode 005. The first transparent electrode 004 is a planar electrode. The second transparent electrode 005 is divided into a plurality of electrode groups 0051, each electrode group 0051 comprising a plurality of sub-electrodes 0052 arranged in parallel (as shown in FIG. 2a).

As shown in FIG. 3, in a 3D display mode, the control unit is specifically configured to apply a first voltage to the sub-electrodes 0052 in each electrode group 0051, and control liquid crystal molecules in a region of the liquid crystal layer 003 corresponding to each electrode group 0051 to deflect so as to form lenticular lens structures 006 corresponding to each electrode group 0051.

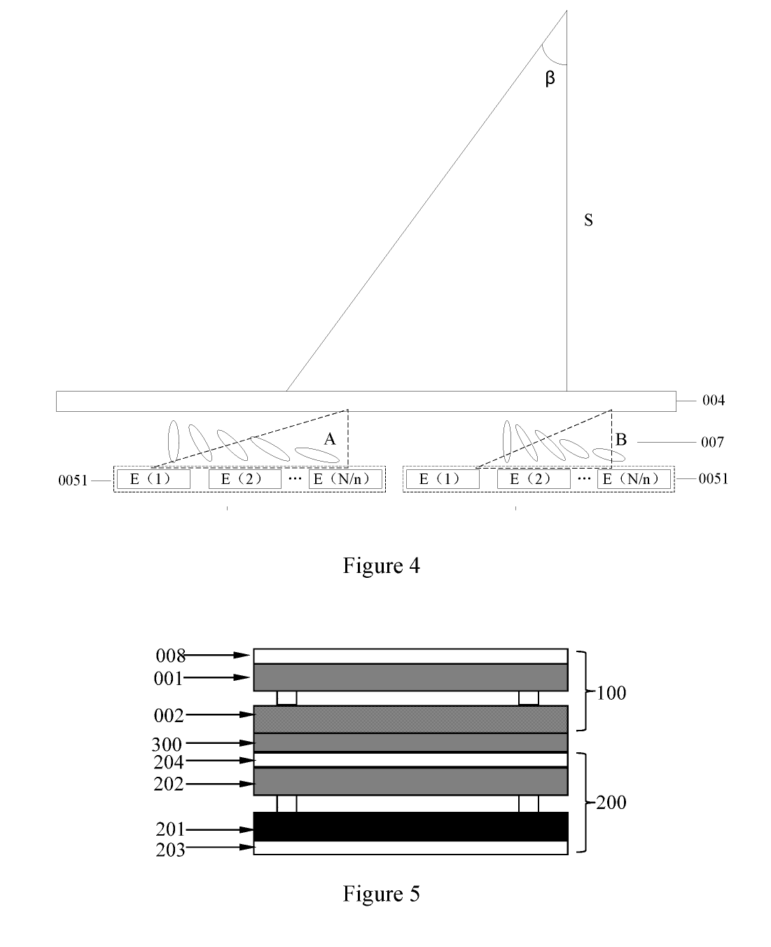

As shown in FIG. 4, in a curved display mode, the control unit is specifically configured to apply a second voltage to the sub-electrodes 0052 in each electrode group 0051, control liquid crystal molecules in a region of the liquid crystal layer 003 corresponding to each electrode group 0051 to deflect so as to form micro-prism structures 007, and control a difference between equivalent optical paths of light in each micro-prism structure 007 to compensate for a difference between optical paths from a position of a viewer to each micro-prism structure 007.

According to the above liquid crystal lens provided by this disclosure, a combination of a curved surface and 3D is realized in case of flat display. This helps to avoid disadvantages of curved display when realized in a physical approach and facilitate an ultrathin product design combining 3D display and curved display.

As shown in FIG. 1, according to a specific embodiment, in the above liquid crystal lens provided by this disclosure, the first transparent electrode 004 can be arranged on a side of the first substrate 001 facing the liquid crystal layer 003. Correspondingly, the second transparent electrode 005 is arranged on a side of the second substrate 002 facing the liquid crystal layer 003. Alternatively, the second transparent electrode 005 can be arranged on a side of the first substrate 001 facing the liquid crystal layer 003. Correspondingly, the first transparent electrode 004 is arranged on a side of the second substrate 002 facing the liquid crystal layer 003. Thus, this disclosure will not be limited by the arrangement of the first and second transparent electrodes.

According to a specific embodiment, in the above liquid crystal lens provided by this disclosure, the second transparent electrode 005 can specifically comprise N sub-electrodes 0052 arranged in parallel and extending in a vertical direction. The sub-electrodes 0052 are divided into n electrode groups, each electrode group comprising N/n sub-electrodes. Specifically, n equals to a resolution of the display panel in a horizontal direction multiplied by a factor 1/P, wherein P is the number of views in 3D display. It should be pointed out that terms such as “a horizontal direction” and “a vertical direction” mentioned above are both relative to a case in which a display device comprising the above liquid crystal lens is hung vertically in use. Obviously, this disclosure is not only limited to that. In fact, those skilled in the art can adjust the direction and orientation of the display device suitably in use upon specific applications, for example, laying it flat on a table.

Furthermore, as shown in FIGS. 2a and 2b, in the liquid crystal lens provided by this disclosure, the sub-electrode 0052 can comprise at least one linear electrode.

Alternatively, as shown in FIGS. 2c and 2d, according to a specific embodiment, in the liquid crystal lens provided by this disclosure, the sub-electrode 0052 can also comprises a plurality of dot electrodes. According to a specific embodiment, the dots can have a regular shape, e.g., circular dots or square dots. Obviously, they can also be dots having an irregular shape, which can take a wide variety of unlimited forms.

Specifically, in a 3D display mode, in order to control the liquid crystal molecules in a region of the liquid crystal layer 003 corresponding to each electrode group 0051 to deflect so as to form lenticular lens structures 006 corresponding to each electrode groups 0051, the control unit will apply different first voltages to the N/n sub-electrodes 0052 comprised in each electrode group 0051 by taking the electrode groups 0051 as repetitive groups, and set values of the first voltages applied to each sub-electrode 0052 such that the liquid crystal molecules corresponding to each electrode group 0051 form a refractive index gradient, thus forming lenticular lens structures. For example, as shown in FIG. 3, the sub-electrodes 0052 comprised in an electrode group 0051 are respectively E(1), E(2), . . . , E(N/n). In this case, the first voltages applied to sub-electrodes E(1) and E(N/n) are the same, the first voltages applied to sub-electrodes E(2) and E(N/n-1) are the same, the first voltage applied to sub-electrode E(1) is greater than the first voltage applied to sub-electrode E(2), and so on.

Specifically, in a curved display mode, in order to control the liquid crystal molecules in a region of the liquid crystal layer 003 corresponding to each electrode group 0051 to deflect so as to form micro-prism structures 007, and use a difference between equivalent optical paths in each micro-prism structure 007 to compensate for a difference between optical paths from the position of the viewer to each micro-prism structure 007 so as to achieve curved display, the control unit will apply to the sub-electrodes in each electrode group 0051 a second voltage different from the first voltage, such that each micro-prism structure having a different distance to the viewer has a different equivalent optical path. Specifically, the closer the micro-prism structures 007 are to the viewer, the greater equivalent optical paths the micro-prism structures 007 have. For example, as shown in FIG. 4, in the liquid crystal lens, a point A is remoter from the viewer than a point B is. Thus, the equivalent optical path in the micro-prism structure at point A is smaller than that in the micro-prism structure at point B. This helps to compensate for a viewing distance from a surface of the liquid crystal lens at point A to the viewer, which is greater than that from a surface of the liquid crystal lens at point B to the viewer.

Optionally, as shown in FIG. 4, in the above liquid crystal lens provided by this disclosure, the difference between equivalent optical paths in any two of the micro-prism structures can be adjusted upon a position of the viewer, that is: S(Binner)−S(Ainner)=S/cos β−S. In this above expression, S is a distance from the viewer to a micro-prism structure B, S/cos β is a distance from the viewer to a micro-prism structure A, β is an opening angle between the micro-prism structure A and the micro-prism structure B when viewed by the viewer, S(Ainner) is an equivalent optical path in the micro-prism structure A, and S(Binner) is an equivalent optical path in the micro-prism structure B.

According to a specific embodiment, in the above liquid crystal lens provided by the present disclosure, through control over the second voltage applied to the sub-electrodes 0052 in the electrode groups 0051, refractive indexes of the formed micro-prism structures 007 can be adjusted, and thus the equivalent optical paths in the micro-prism structures 007 can be controlled. Besides, the greater equivalent optical paths the micro-prism structures 007 have, the smaller the difference is between voltages applied to the transparent electrodes on two opposing sides of the liquid crystal layer corresponding to the micro-prism structures 007. For example, in FIG. 4, the equivalent optical path in the micro-prism structure 007 formed at point A is smaller than that in the micro-prism structure 007 formed at point B. Therefore, it is required that the refractive index nA of the micro-prism structure 007 formed at point A be smaller than the refractive index nB of the micro-prism structure formed at point B. Based on that, the difference of voltages applied to the micro-prism structure 007 at point A is greater than the difference of voltages applied to the micro-prism structure 007 at point B.

According to a specific embodiment, the above liquid crystal lens provided by this disclosure can further comprise: an eye tracking unit, which is configured to determine a position of the viewer in front of the liquid crystal lens. After that, values of voltages applied to each micro-prism structure formed in a curved display mode can be adjusted based on the determined position of the viewer. Thereby, the equivalent optical paths of light in each micro-prism structure can be adjusted. Obviously, the above liquid crystal lens can also be provided without an eye tracking unit. By default, the position of the viewer can be set as the position of a central line of the liquid crystal lens.

According to a specific embodiment, in the liquid crystal lens provided by this disclosure, the micro-prism structure formed in a curved display mode can be a triangular prism structure and/or a quadrangular prism structure. Moreover, the triangular prism structure can be specifically a right-angle prism structure, which can take a wide variety of forms.

Optionally, as shown in FIG. 1, the liquid crystal display provided by this disclosure can further comprise a polarizer 008 located on a side of the first substrate 001 facing away from the liquid crystal layer 003. In this way, as light exiting from the liquid crystal lens is linearly polarized by the polarizer 008, the display effect can be improved effectively.

Based on a same inventive concept, an embodiment of this disclosure further provides a display device, comprising the liquid crystal lens provided by the above embodiment of this disclosure. The display device can be any product or component having a display function, such as a handset, a tablet computer, a television, a display, a notebook computer, a digital photo frame and a navigator. For implementations of the display device, the above embodiment of the liquid crystal lens can be referred to, and repetitive parts will not be illustrated for simplicity.

Specifically, an embodiment of this disclosure provides a display device, as shown in FIG. 5. The display device comprises a liquid crystal lens 100 provided by this disclosure as well as a display panel 200 arranged below the liquid crystal lens 100 and configured to display polarized light.

According to a specific embodiment, the liquid crystal lens 100 and the display panel 200 can be adhered to each other fixedly via an optically clear adhesive 300.

Specifically, as shown in FIG. 5, in the display device provided by this disclosure, the display panel 200 can be implemented by a liquid crystal display panel, or an electroluminescent display panel with a polarizer provided on a display surface. For example, when a liquid crystal display panel is used, as shown in FIG. 5, the liquid crystal display panel specifically comprises: a first substrate 201 and a second substrate 202 arranged oppositely; a first polarizer 203 arranged below the first substrate 201; and a second polarizer 204 arranged above the second substrate 202.

The embodiments of this disclosure provide a liquid crystal lens and a display device. The liquid crystal lens comprises: a first substrate and a second substrate arranged oppositely; a liquid crystal layer between the first substrate and the second substrate; a first transparent electrode and a second transparent electrode between the first substrate and the second substrate, wherein the first transparent electrode and the second transparent electrode are located on two opposing sides of the liquid crystal layer respectively; and a control unit for applying a voltage to the first transparent electrode and the second transparent electrode. The first transparent electrode is a planar electrode. The second transparent electrode is divided into a plurality of electrode groups, each electrode group comprising a plurality of sub-electrodes. In a 3D display mode, the control unit is specifically configured to apply a first voltage to the sub-electrodes in each electrode group, and control liquid crystal molecules in a region of the liquid crystal layer corresponding to each electrode group to deflect so as to form lenticular lens structures corresponding to each electrode group, thereby realizing a naked-eye 3D display function. In a curved display mode, the control unit is specifically configured to apply a second voltage to the sub-electrodes in each electrode group, control liquid crystal molecules in a region of the liquid crystal layer corresponding to each electrode group to deflect so as to form micro-prism structures, and control a difference between equivalent optical paths of light in each micro-prism structure to compensate for a difference between optical paths from the position of the viewer to each micro-prism structure, thereby realizing curved display. The above liquid crystal lens realizes a combination of a curved surface and 3D in case of flat display. This helps to avoid disadvantages of curved display when realized in a physical approach and facilitate an ultrathin product design combining 3D display and curved display.

Obviously, those skilled in the art can make various improvements and modifications to this disclosure without deviating from the spirits and scopes of this disclosure. Thus if the improvements and modifications to this disclosure fall within the scopes of the claims of this disclosure and the equivalent techniques thereof, they are intended to be included in this disclosure too.

1. A liquid crystal lens comprising:
a first substrate and a second substrate arranged opposite the first substrate;
a liquid crystal layer between the first substrate and the second substrate;
a first transparent electrode and a second transparent electrode between the first substrate and the second substrate, wherein the first transparent electrode and the second transparent electrode are located on two opposing sides of the liquid crystal layer; and
a control unit for applying voltages to the first transparent electrode and the second transparent electrode, wherein
the first transparent electrode is a planar electrode, and the second transparent electrode is divided into a plurality of electrode groups, each of the electrode groups comprising a plurality of sub-electrodes, and wherein
in a 3D display mode, the control unit is configured to apply a first voltage to the sub-electrodes in each of the electrode groups, and control liquid crystal molecules in a region of the liquid crystal layer corresponding to each of the electrode groups to deflect so as to form lenticular lens structures corresponding to each of the electrode groups; and
in a curved display mode, the control unit is configured to apply a second voltage to the sub-electrodes in each of the electrode groups, control liquid crystal molecules in a region of the liquid crystal layer corresponding to each of the electrode groups to deflect so as to form micro-prism structures, and control a difference between equivalent optical paths of light in each of the micro-prism structures to compensate for a difference between optical paths from a position of a viewer to each of the micro-prism structures.

2. The liquid crystal lens according to claim 1, wherein the plurality of sub-electrodes in each of the electrode groups are a plurality of strip sub-electrodes arranged in parallel.

3. The liquid crystal lens according to claim 1, further comprising: an eye tracking unit configured to determine a position of the viewer in front of the liquid crystal lens.

4. The liquid crystal lens according to claim 1, wherein the closer the micro-prism structures are to the viewer, the greater equivalent optical paths the micro-prism structures have.

5. The liquid crystal lens according to claim 4, wherein a difference between equivalent optical paths in any two of the micro-prism structures is: S(Binner)−S(Ainner)=S/cos β−S;
wherein S is a distance from the viewer to a micro-prism structure B, S/cos β is a distance from the viewer to a micro-prism structure A, β is an opening angle between the micro-prism structure A and the micro-prism structure B when viewed by the viewer, S(Ainner) is an equivalent optical path in the micro-prism structure A, and S(Binner) is an equivalent optical path in the micro-prism structure B.

6. The liquid crystal lens according to claim 1, wherein the greater equivalent optical paths the micro-prism structures have, the smaller a difference is between voltages applied to the first and second transparent electrodes on two opposing sides of the liquid crystal layer corresponding to the micro-prism structures.

7. The liquid crystal lens according to claim 1, wherein the micro-prism structure comprises at least one of a triangular prism structure and a quadrangular prism structure.

8. The liquid crystal lens according to claim 1, wherein the sub-electrode comprises at least one linear electrode or a plurality of dot electrodes.

9. The liquid crystal lens according to claim 1, further comprising: a polarizer located on a side of the first substrate facing away from the liquid crystal layer.

10. A display device comprising:
the liquid crystal lens according to claim 1; and
a display panel arranged below the liquid crystal lens and configured to display polarized light.

11. The display device according to claim 10, wherein the display panel is a liquid crystal display panel or an electroluminescent display panel with a polarizer provided on a display surface.

12. The liquid crystal lens according to claim 2, wherein the sub-electrode comprises at least one linear electrode or a plurality of dot electrodes.

13. The liquid crystal lens according to claim 3, wherein the sub-electrode comprises at least one linear electrode or a plurality of dot electrodes.

14. The liquid crystal lens according to claim 4, wherein the sub-electrode comprises at least one linear electrode or a plurality of dot electrodes.

15. The liquid crystal lens according to claim 6, wherein the sub-electrode comprises at least one linear electrode or a plurality of dot electrodes.

16. The liquid crystal lens according to claim 7, wherein the sub-electrode comprises at least one linear electrode or a plurality of dot electrodes.

17. The liquid crystal lens according to claim 2, further comprising: a polarizer located on a side of the first substrate facing away from the liquid crystal layer.

18. The liquid crystal lens according to claim 3, further comprising: a polarizer located on a side of the first substrate facing away from the liquid crystal layer.

19. The liquid crystal lens according to claim 4, further comprising: a polarizer located on a side of the first substrate facing away from the liquid crystal layer.

20. The liquid crystal lens according to claim 6, further comprising: a polarizer located on a side of the first substrate facing away from the liquid crystal layer.
